(19) United States
(12) Patent Application Publication
(10) Pub. No.: US 2012/0105884 A1
(43) Pub. Date: May 3, 2012

(54) INFORMATION PROCESSING APPARATUS, CONTROL METHOD OF INFORMATION PROCESSING APPARATUS, AND STORAGE MEDIUM

(75) Inventor: Takeshi Matsumura, Yokohama-shi (JP)

(73) Assignee: CANON KABUSHIKI KAISHA, Tokyo (JP)

(21) Appl. No.: 13/124,690

(22) PCT Filed: Oct. 6, 2010
(86) PCT No.: PCT/JP2010/067992

§ 371 Date: Apr. 18, 2011

(30) Foreign Application Priority Data
Nov. 25, 2009 (JP) 2009-267826

(51) Int. Cl. G06F 3/12

(52) U.S. Cl. 358/1.13

(57) ABSTRACT

An image processing apparatus of the present invention is provided with input means for inputting a job, selection means for selecting circuit configuration data corresponding to a type of the job input by the input means from a plurality of circuit configuration data stored in the storage means, reconfiguration means for reconfiguring the circuitry of the data processing means using the circuit configuration data selected by the selection means, and control means for causing the data processing means whose circuitry has been reconfigured by the reconfiguration means to execute the job input by the input means.

### TECHNICAL FIELD

The present invention relates to an information processing apparatus provided with a device whose circuitry can be reconfigured, a control method of the information processing apparatus, and a storage medium.

### BACKGROUND ART

A device whose circuitry can be reconfigured (programmable logic device) is an integrated circuit that holds circuit configuration data relating to elements and wiring configuring its circuitry in an external storage apparatus (ROM, flash memory, etc.), reads held circuit configuration data as necessary, and changes the connection state between a plurality of internal logic elements based on the read circuit configuration data to enable arbitrary logic circuits to be realized. For example, in fields such as image processing that are marked by the increasing sophistication of data to be processed, there are strong demands to change this connection state according to the type of image and the processing status. In such cases, an FPGA (Field Programmable Gate Array), which is a typical programmable logic device, is mounted on processing apparatuses, and circuit configuration data optimized to the required specifications of each processing apparatus is generated to enable relevant processing.

Also, in the case where a plurality of hardware functions are to be executed by a processing apparatus, there is a technique that involves storing a plurality of circuit configuration data for realizing the hardware functions in an external storage apparatus, and selecting and reading out circuit configuration data stored in the external storage apparatus according to required processing.

Also, there are particularly strong calls to reduce the power consumption of large-scale semiconductor integrated circuits given the large amounts of power they use. Thus, there exist programmable logic devices provided with both normal type cells and low power consumption type cells that operate at a lower speed and use less power than the normal type cells, and techniques for selectively using these cells as necessary from the viewpoint of operation speed and power consumption (e.g., see Japanese Patent Laid-Open No. 2007-82017 (Patent Document 1)).

Here, with the conventional technology, a hardware function to be executed is firstly allocated to a normal type cell, and the allocation is changed from the normal type cell to a low power consumption type cell as necessary, in the case where, for example, the hardware function does not need to be executed at a fast operation speed.

However, in the case where functions allocated to low power consumption type cells are hardly used, most operations will be performed using the normal type cells. A situation can thus arise where a reduction in power consumption cannot be achieved.

### SUMMARY OF INVENTION

The present invention has been made in consideration of the above problems, and provides a mechanism enabling a further reduction in power consumption by controlling reconfiguration of the circuitry of a device having normal type cells and low power consumption type cells.

According to one aspect of the present invention, there is provided an image processing apparatus having data processing means whose circuitry can be reconfigured and that includes a first type of cell and a second type of cell having lower power consumption than the first type of cell, and storage means for storing, for each type of job, circuit configuration data for configuring the circuitry that preferentially allocates a function for executing the job to the second type of cell, comprises: input means for inputting a job; selection means for selecting circuit configuration data corresponding to a type of the job input by the input means from a plurality of circuit configuration data stored in the storage means; reconfiguration means for reconfiguring the circuitry of the data processing means using the circuit configuration data selected by the selection means; and control means for causing the data processing means whose circuitry has been reconfigured by the reconfiguration means to execute the job input by the input means.

According to another aspect of the present invention, there is provided a control method of an image processing apparatus having data processing means whose circuitry can be reconfigured and that includes a first type of cell and a second type of cell having lower power consumption than the first type of cell, and storage means for storing, for each type of job, circuit configuration data for configuring the circuitry that preferentially allocates a function for executing the job to the second type of cell, comprises: a step in which input means of the information processing apparatus inputs a job; a step in which selection means of the information processing apparatus selects circuit configuration data corresponding to a type of the job input by the input means from a plurality of circuit configuration data stored in the storage means; a step in which reconfiguration means of the information processing apparatus reconfigures the circuitry of the data processing means using the circuit configuration data selected by the selection means; and a step in which control means of the information processing apparatus causes the data processing means whose circuitry has been reconfigured by the reconfiguration means to execute the job input by the input means.

According to another aspect of the present invention, there is provided a storage medium storing a program for causing, an information processing apparatus having data processing means whose circuitry can be reconfigured and that includes a first type of cell and a second type of cell having lower power consumption than the first type of cell, and storage means for storing, for each type of job, circuit configuration data for configuring the circuitry that preferentially allocates a function for executing the job to the second type of cell, to function as: input means for inputting a job; selection means for selecting circuit configuration data corresponding to a type of the job input by the input means from a plurality of circuit configuration data stored in the storage means; reconfiguration means for reconfiguring the circuitry of the data processing means using the circuit configuration data selected by the selection means; and control means for causing the data processing means whose circuitry has been reconfigured by the reconfiguration means to execute the job input by the input means.

According to the present invention, a mechanism enabling a further reduction in power consumption by controlling reconfiguration of the circuitry of a device having normal type cells and low power consumption type cells can be provided.

Further features of the present invention will become apparent from the following description of exemplary embodiments with reference to the attached drawings.

### BRIEF DESCRIPTION OF DRAWINGS

FIG. 1 shows a hardware configuration of an information processing system according to an Embodiment 1 of the present invention.

FIG. 2 shows a functional configuration of an image processing unit.

FIG. 3 shows a format of image data.

FIG. 4 shows a format of circuit configuration data.

FIG. 5 shows a procedure for generating circuit configuration data and wiring data.

FIG. 6 shows a correspondence relation between jobs to be executed and functions to be used.

FIG. 7 shows a procedure for reconfiguring circuitry.

FIG. 8 shows a correspondence relation between jobs to be executed and configuration data.

### DESCRIPTION OF EMBODIMENTS

Hereinafter, embodiments of the present invention will be described in detail with reference to the accompanying drawings. Note that the following embodiments are not intended to limit the claims of the invention, and not all combinations of features described in the embodiments are essential for the invention.

### Embodiment 1

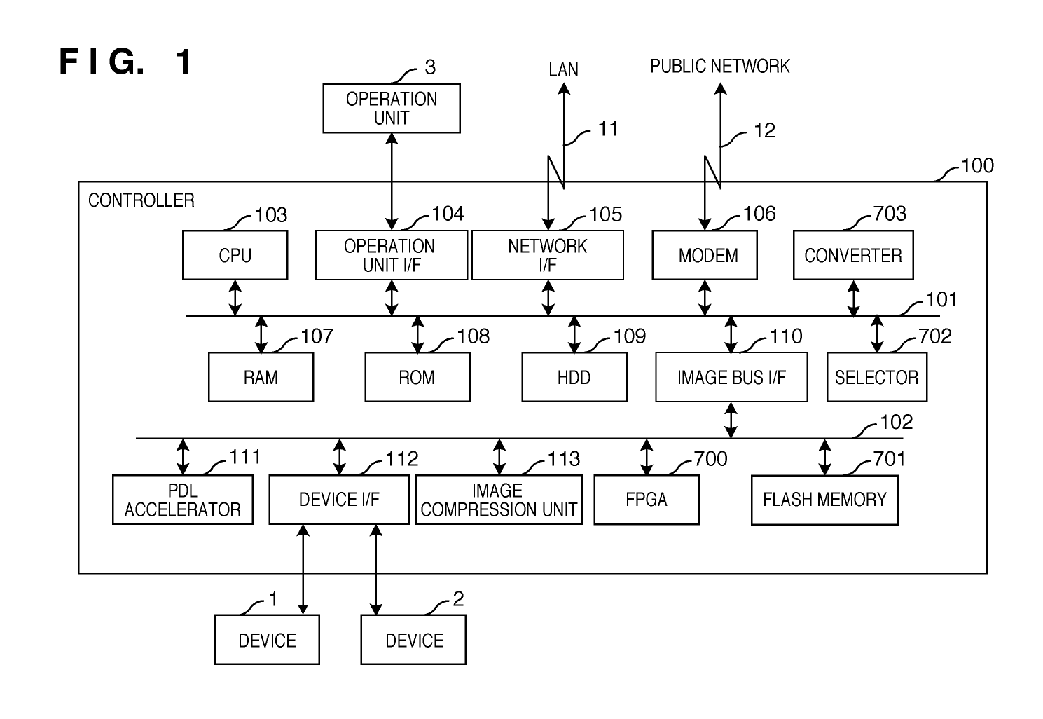

Hardware Configuration of Information Processing System (FIG. 1)

An information processing system includes a controller 100, a device 1 (e.g., an image input apparatus such as a scanner), a device 2 (e.g., an image output apparatus such as a printer), and an operation unit 3.

The controller 100 controls input and output of image information and device information by being connected to the devices 1 and 2 and to networks such as a LAN 11 and a public network 12. That is, the controller 100 functions as an information processing apparatus that executes multiple types of jobs, and, specifically, is provided with the following constituent elements.

A CPU 103 controls the overall system. A RAM 107 is a system work memory for the CPU 103 to perform operations, and is also used as an image memory for temporarily storing image data.

A ROM 108 is used as a boot ROM, and stores a system boot program. The ROM 108 is also used to store circuit configuration data (device configuration data) for expanding in an FPGA.

A HDD 109 (Hard Disk Drive) stores system software, image data, and personal data such as address books. This data is encoded and stored by an image compression unit 113 that will be described later, and restored when it is to be used. Note that in the case where an HDD is not provided, this data is assumed to be stored on another storage medium (flash memory 701, etc.).

An operation unit I/F 104 is an interface for connecting the operation unit 3 to the controller 100, and outputs image data to be displayed on the operation unit 3 to the operation unit 3. Also, the operation unit I/F 104 transmits information input by a user with the operation unit 3 to the CPU 103.

A network I/F 105 is connected to the LAN 11, and inputs and outputs information. A modem 106 is connected to the public network 12, and performs modulation and demodulation for transmitting and receiving data. The above constituent elements are disposed on a system bus 101.

An image bus I/F 110 is a bus bridge for connecting the system bus 101 and an image bus 102 that transfers image data at high speed, and converting data structures. The image bus 102 is constituted by a high-speed bus such as a PCI bus or an IEEE 1394 bus. The following constituent elements are disposed on the image bus 102.

A PDL accelerator 111 generates image data 800 from PDL code. A device I/F 112 connects the devices 1 and 2 to the controller 100, and performs synchronous and asynchronous conversion of image data. An image compression unit 113 performs JPEG compression and decompression on multi-valued image data, and JBIG, MMR, MH compression and decompression on binary image data. Image data to be compressed or decompressed is read out from the HDD 109, and again stored in the HDD 109 after being compressed or decompressed.

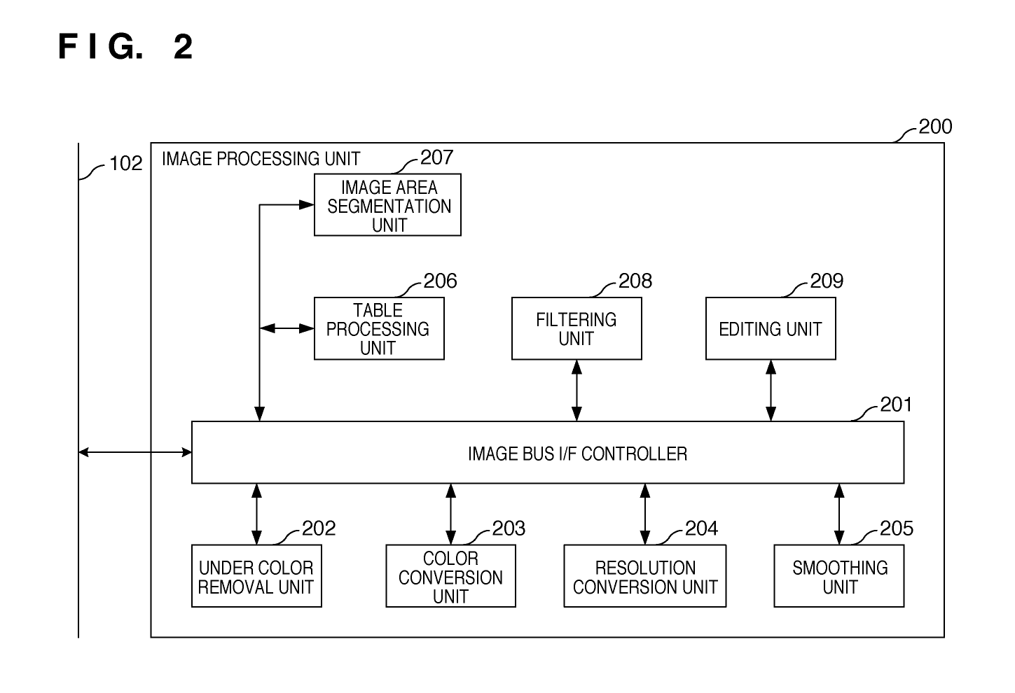

An FPGA 700 (device) is provided with a function of expanding circuit configuration data having an image processing algorithm, and configuring a required image processing algorithm with hardware. That is, the FPGA 700 functions as an image processing unit 200 that will be described later with FIG. 2. The FPGA 700 generates an end flag when one job has been processed. The FPGA 700 has normal type cells (first type of cell; hereinafter, simply “normal cells”), and low power consumption type cells (second type of cell, hereinafter, simply “low power consumption cells”) having a lower operation speed and lower power consumption than the normal cells. Note that in the present embodiment two types of cells with different levels of power consumption are provided, but cells of three or more levels may be provided. Circuit configuration data for expanding in the FPGA 700 is stored in the flash memory 701.

Functional Configuration of Image Processing Unit 200 (FIG. 2)

The functions of the image processing unit 200 are realized by expanding circuit configuration data relating to image processing in the FPGA 700, as described above.

An image bus I/F controller 201 is connected to the image bus 102, and controls the bus access sequence and performs control of and timing generation for the constituent elements in the image processing unit 200. An under color removal unit 202 removes background color in the case where, for instance, image data obtained by reading an original having a light colored background is received. A color conversion unit 203 performs color conversion in accordance with the output characteristics of the printer.

A resolution conversion unit 204 performs resolution conversion for converting image data received from the LAN 11 or the public network 12 to the resolution of the device 2 serving as an image output apparatus. A screen processing unit that is not shown performs binary processing on image data. A smoothing unit 205 performs processing to smooth jaggy edges of image data that has undergone resolution conversion (jaggedness in an image appearing in the monochrome boundary portion of diagonal lines, etc.).

An image area segmentation unit 207 determines an image area by detecting a character area from an input image, and generates an image area signal to be used in subsequent image processing. A table processing unit 206 performs table conversion for converting read image data constituted by brightness data to density data. A filtering unit 208 performs convolution with a digital spatial filter designed for edge enhancement or the like.

An editing unit 209 recognizes closed areas encircled with a marker pen, for example, in the input image data, and performs image modification such as shading, hatching and negative-positive inversion on the image data in the closed areas. The processed image data is transferred to the image bus 102, again via the image bus I/F controller 201.

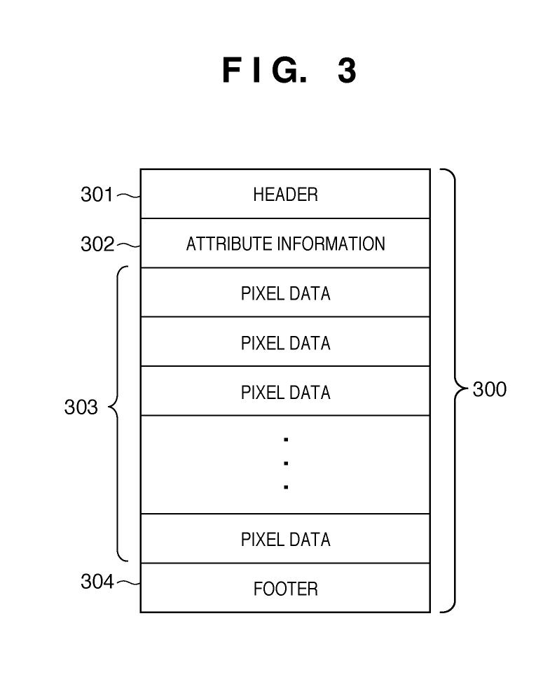

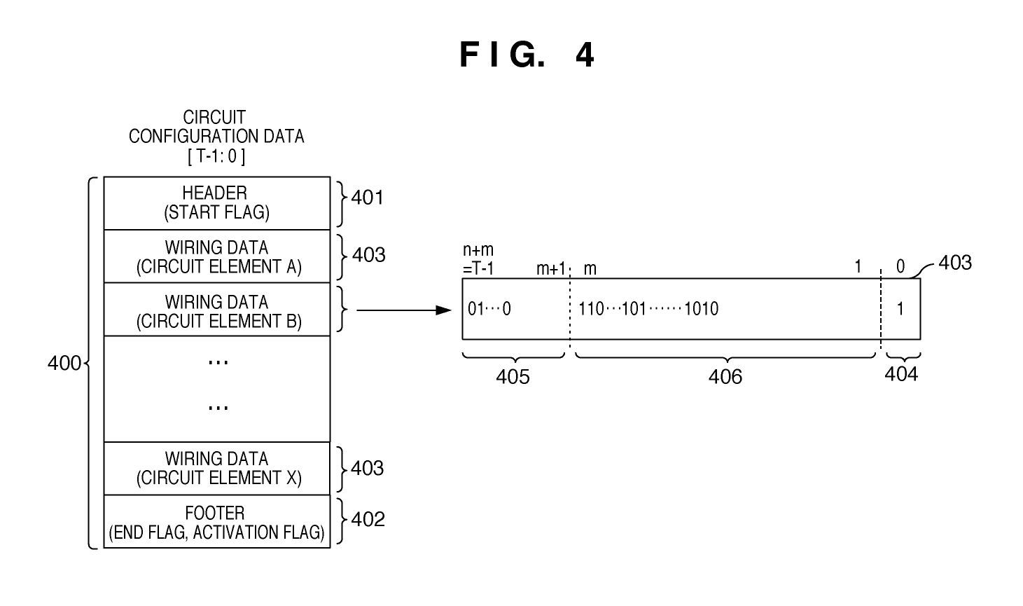

Examples of Image Data and Circuit Configuration Data (FIGS. 3, 4)

Image data 300 includes a header 301, attribute information 302, pixel data 303 and a footer 304, as shown in FIG. 3. The header 301 includes a job ID, the number of pages, information relating to the length and width of the image data 300, and a start flag used to indicate the start of the image data 300. The attribute information 302 includes information relating to printing of an image such as color, resolution and print mode. The pixel data 303 includes image data for each pixel. The footer 304 includes an end flag used to indicate the end of the image data 300.

Circuit configuration data 400 (T-bit data width) includes a header 401, a footer 402 and wiring data 403, as shown in FIG. 4. The header 401 includes a start flag used to indicate the start of the circuit configuration data 400, and circuit information of the circuit configuration data 400. The footer 402 includes an end flag used to indicate the end of the circuit configuration data 400, and an activation flag used to activate the FPGA 700.

The wiring data 403 includes a start bit 404, an end bit/error check bit 405, and a wiring data bit 406. The start bit 404 (1-bit data width) is added to the head of the wiring data, and is used to show the beginning of the wiring data. The end bit/error check bit 405 (n-bit data width) is added to the end of the wiring data, and is used to check the validity of the wiring data and to show the end of the wiring data. The wiring data bit 406 (m-bit data width) is used to represent the connection state between logic elements of the FPGA 700.

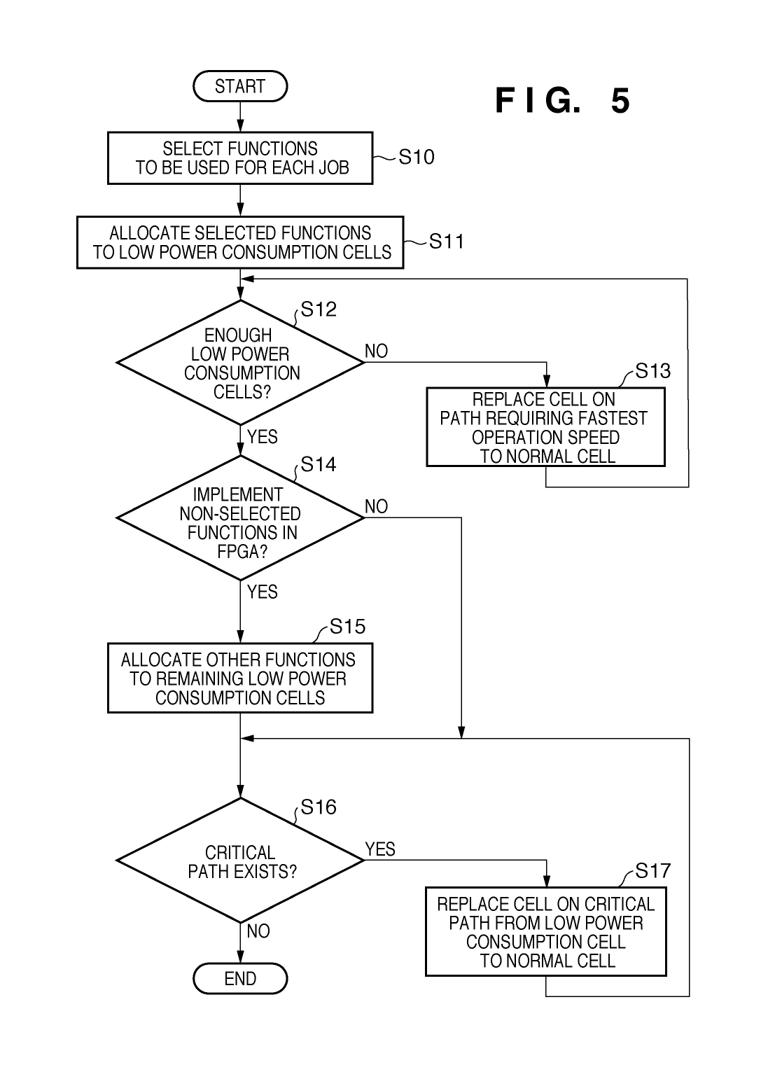

Procedure for Generating Circuit Configuration Data 400 (FIG. 5)

The process of generating the circuit configuration data 400 shown here is carried out by a developer at the product development stage, and generated circuit configuration data is stored in the ROM 108.

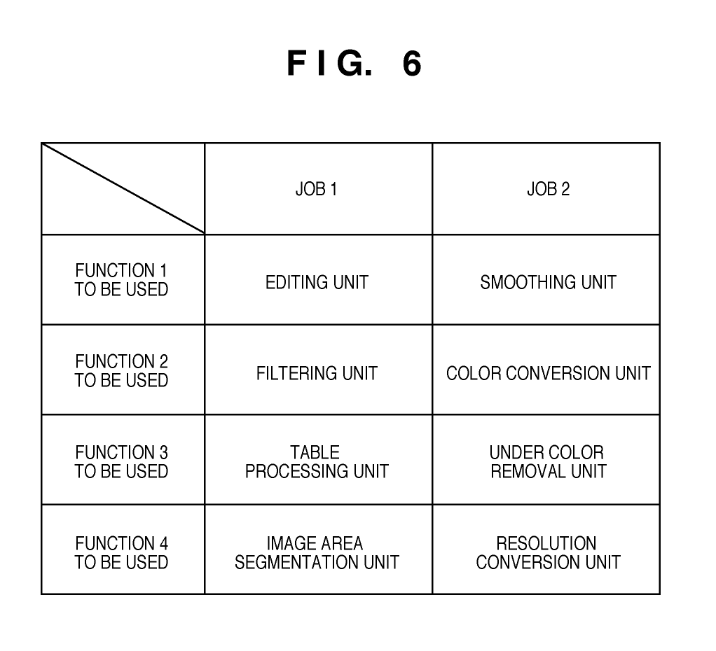

Firstly, the developer selects functions to be used for each job (S10). Here, the functions to be used for each job are preset according to the content of required jobs. For example, as shown in FIG. 6, functions 1 to 4 to be selected as functions for use with a job 1 are the editing unit 209, the filtering unit 208, the table processing unit 206 and the image area segmentation unit 207, and functions 1 to 4 to be selected as functions for use with a job 2 are the smoothing unit 205, the color conversion unit 203, the under color removal unit 202 and the resolution conversion unit 204.

Next, the developer attempts to preferentially allocate selected functions to low power consumption cells in the FPGA 700 and generate circuit configuration data 400 thereof (S11). The developer then judges whether all selected functions could be allocated to low power consumption cells (S12). If at least some of the functions could not be allocated, the developer carries out replacement so as to allocate selected functions that need a high-speed path to normal cells (S13). The developer repeats the processing of S12 and S13 until all of the selected functions are allocated to low power consumption cells or normal cells.

On the other hand, if all of the function could be allocated to low power consumption cells at S11, the developer judges whether to implement the remaining functions that were not selected (S14). For example, since the editing unit 209, the filtering unit 208, the table processing unit 206 and the image area segmentation unit 207 are selected at S10 in the case of executing job 1, the remaining functions here are the smoothing unit 205, the color conversion unit 203, the under color removal unit 202 and the resolution conversion unit 204. That is, having allocated the four functions of job 1, the developer is able to increase the functions that are realizable when job 1 is received, by additionally allocating functions that he or she wants to add from the functions of job 2.

In the case of implementing the remaining functions, the developer allocates the other functions to the remaining low power consumption cells (S15). Note that if it is not possible to allocate some of the other functions to low power consumption cells, the developer can carry out replacement so as to allocate other functions that require a high-speed path to normal cells, similarly to S13.

On the other hand, in the case of not implementing the remaining functions at S14, the developer judges whether there exists a path (critical path) within the current circuit configuration data 400 that is short of time (S16). Specifically, the developer judges that a critical path exists if there is a path whose required operating time (clock cycle time) exceeds a predetermined time.

If a critical path does not exist, the developer ends the data generation. If a critical path exists at S16, the developer replaces the logic allocated to the low power consumption cell on the critical path to a normal cell (S17). The developer thereby removes the critical path. The developer repeatedly carries out S16 and S17 until there are no critical paths, and ends the generation of circuit configuration data.

Circuit configuration data thus generated is stored in the ROM 108. Note that, here, in the case where there are not enough low power consumption cells, paths that require a faster operating speed are replaced to normal cells at S13, but paths with a lower usage rate may be replaced to normal cells. This is because of it being highly unlikely that a reduction in power consumption would be achieved even if a path with a low usage rate was allocated to a low power consumption cell.

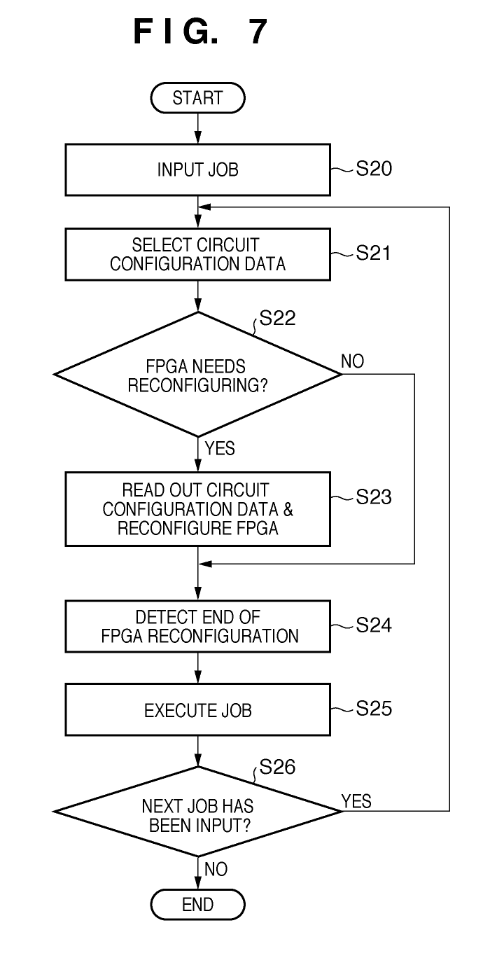

Procedure for Reconfiguring Circuitry (FIG. 7)

The circuitry reconfiguration process shown here is performed by the CPU 103 of the controller 100 when the information processing apparatus is actually used by a user after shipping.

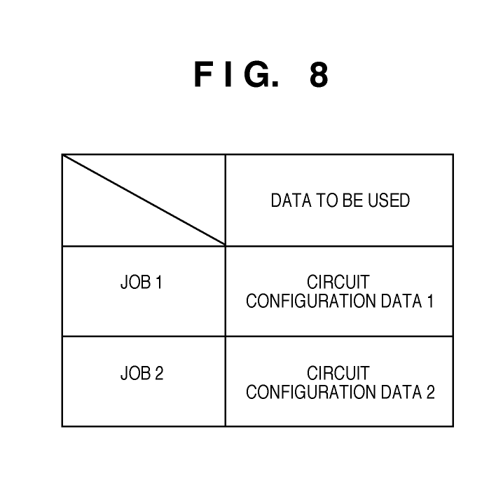

The CPU 103 receives a job via the LAN 11 or the network I/F 105 (S20). The CPU 103 then inputs the received job to the PDL accelerator 111, and generates image data. Next, the CPU 103 selects circuit configuration data corresponding to the received job from the plurality of circuit configuration data generated in advance (S21). The CPU 103 determines the circuit configuration data corresponding to the received job with reference to a table in which circuit configuration data has been corresponded to each job, as shown in FIG. 8, for example.

Next, the CPU 103 determines whether circuitry on the FPGA 700 needs to be reconfigured (S22). In other words, the CPU 103 determines whether the functions included in the circuit configuration data selected at S21 can be realized with circuit configuration data actually reflected as circuitry.

In the case where circuitry on the FPGA 700 needs to be reconfigured, the CPU 103 reconfigures the circuitry on the FPGA 700 with the circuit configuration data selected at S21 (see FIG. 4), after expanding the corresponding circuit configuration data 400 from the ROM 108 in the flash memory 701 (S23). The CPU 103 detects a sign generated by the FPGA 700 indicating that reconfiguration has ended (S24). Subsequently, the CPU 103 causes the FPGA 700 to execute the job input at S20 (S25). For example, if the input job is an image processing job, the CPU 103 transfers image data 300 including pixel data to the FPGA 700, and causes the FPGA 700 to execute the image processing job. The CPU 103 performs optimal register setting for the FPGA 700 using the header 301 and the attribute information 302. Execution of the job ends when the FPGA 700 subsequently detects the end of the job from the footer 304. When the job ends, the CPU 103 determines whether the next job has been input (S26). The CPU 103 again starts the processing from S21 if the next job has been input, and ends the series of processing if the next job has not been input.

As mentioned above, according to the present embodiment, the percentage of functions mapped onto low power consumption cells that are executed can be increased, since circuitry is reconfigured after selecting circuit configuration data corresponding to a received job from a plurality of circuit configuration data that preferentially allocate functions for executing jobs to low power consumption cells. A further reduction in the power consumption of FPGAs can thereby be achieved.

Also, in the case where a low power consumption cell to which a function corresponding to a job has been allocated exists on a critical path, the allocation destination of the function allocated to the low power consumption cell on the critical path is changed to a normal cell, thus enabling a decrease in operation speed caused by the function being preferentially allocated to the low power consumption cell to be suppressed.

Note that in the present embodiment, an information processing apparatus that causes the FPGA 700 to function as the image processing unit 200 by providing the FPGA 700 with image processing functions was described, but the FPGA 700 can also be provided with functions other than image processing functions.

### Other Embodiments

Aspects of the present invention can also be realized by a computer of a system or apparatus (or devices such as a CPU or MPU) that reads out and executes a program recorded on a memory apparatus to perform the functions of the above-described embodiment(s), and by a method, the steps of which are performed by a computer of a system or apparatus by, for example, reading out and executing a program recorded on a memory apparatus to perform the functions of the above-described embodiment(s). For this purpose, the program is provided to the computer for example via a network or from a recording medium of various types serving as the memory apparatus (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-267826, filed Nov. 25, 2009, which is hereby incorporated by reference herein in its entirety.

1. An image processing apparatus having data processing means whose circuitry can be reconfigured and that includes a first type of cell and a second type of cell having lower power consumption than the first type of cell, and storage means for storing, for each type of job, circuit configuration data for configuring the circuitry that preferentially allocates a function for executing the job to the second type of cell, comprising:
input means for inputting a job;
selection means for selecting circuit configuration data corresponding to a type of the job input by the input means from a plurality of circuit configuration data stored in the storage means;
reconfiguration means for reconfiguring the circuitry of the data processing means using the circuit configuration data selected by the selection means; and
control means for causing the data processing means whose circuitry has been reconfigured by the reconfiguration means to execute the job input by the input means.

2. The image processing apparatus according to claim 1,
wherein in a case where a cell of the second type to which a function corresponding to each job is allocated exists on a critical path, the plurality of circuit configuration data are created by changing an allocation destination of the function allocated to the cell on the critical path to a cell of the first type.

3. The image processing apparatus according to claim 1,
wherein in a case where not all functions for each job could be allocated to the second type of cell, the plurality of circuit configuration data are created by changing an allocation destination of some of the functions from the second type of cell to the first type of cell.

4. The image processing apparatus according to claim 1,
wherein in a case where not all functions for each job could be allocated to the second type of cell, the plurality of circuit configuration data are created by changing an allocation destination of a function that needs to operate at a fastest speed among all of the functions from the second type of cell to the first type of cell.

5. The image processing apparatus according to claim 1,
wherein in a case where not all functions for each job could be allocated to the second type of cell, the plurality of circuit configuration data are created by changing an allocation destination of a function having a lowest usage rate among all of the functions from the second type of cell to the first type of cell.

6. A control method of an image processing apparatus having data processing means whose circuitry can be reconfigured and that includes a first type of cell and a second type of cell having lower power consumption than the first type of cell, and storage means for storing, for each type of job, circuit configuration data for configuring the circuitry that preferentially allocates a function for executing the job to the second type of cell, comprising:
a step in which input means of the information processing apparatus inputs a job;
a step in which selection means of the information processing apparatus selects circuit configuration data corresponding to a type of the job input by the input means from a plurality of circuit configuration data stored in the storage means;
a step in which reconfiguration means of the information processing apparatus reconfigures the circuitry of the data processing means using the circuit configuration data selected by the selection means; and
a step in which control means of the information processing apparatus causes the data processing means whose circuitry has been reconfigured by the reconfiguration means to execute the job input by the input means.

7. A storage medium storing a program for causing, an information processing apparatus having data processing means whose circuitry can be reconfigured and that includes a first type of cell and a second type of cell having lower power consumption than the first type of cell, and storage means for storing, for each type of job, circuit configuration data for configuring the circuitry that preferentially allocates a function for executing the job to the second type of cell, to function as:
input means for inputting a job;
selection means for selecting circuit configuration data corresponding to a type of the job input by the input means from a plurality of circuit configuration data stored in the storage means;
reconfiguration means for reconfiguring the circuitry of the data processing means using the circuit configuration data selected by the selection means; and
control means for causing the data processing means whose circuitry has been reconfigured by the reconfiguration means to execute the job input by the input means.
